(19) United States
(12) Patent Application Publication
(10) Pub. No.: US 2021/0164261 A1
(43) Pub. Date: Jun. 3, 2021

(54) LIGHT AND GRIP DEVICE

(71) Applicant: Armond Floyd, Watchung, NJ (US)

(72) Inventor: Armond Floyd, Watchung, NJ (US)

(21) Appl. No.: 17/174,877

(22) Filed: Feb. 12, 2021

Related U.S. Application Data
(63) Continuation of application No. 15/948,244, filed on Apr. 9, 2018, now abandoned.
(60) Provisional application No. 62/482,893, filed on Apr. 7, 2017.

(51) Int. Cl. E05B 19/00; E05B 17/10; E05B 19/04

(52) U.S. Cl. CPC E05B 19/00; E05B 19/04; E05B 17/103

(57) ABSTRACT

A disclosed device may have a clamping mechanism operably coupled to a rotatable positioning mechanism, the clamping mechanism being intended to retain a position of at least one key. The device is shaped such that additional torque can be applied to the key when rotating the key when inserted in a lock. In some embodiments, a light source may be included with the device.

### CLAIM OF PRIORITY

This application is a continuation application of U.S. application Ser. No. 15/948,244 filed Apr. 9, 2018, which claims priority to U.S. Application 62/482,893 filed on Apr. 7, 2017, the contents of which are fully incorporated herein by reference in their entirety.

### FIELD OF THE EMBODIMENTS

The field of the present invention and its embodiments relate to gripping devices incorporating lighting elements, namely gripping devices for keys. In particular, gripping devices that assist users in turning keys to enter a home, car, office, safe, etc.

### BACKGROUND OF THE EMBODIMENTS

A majority of locks including but not limited to door locks and ignition system locks involve inserting a key into a keyhole and turning the key to engage the lock. The shank of a key is typically the longer than the handle portion and contains grooves. The grooves on the shank are configured to contact various pins, tumblers, and other locking mechanisms of a lock, with the result being that rotation of the inserted key rotates the lock to its desired location.

The head or handle of the key is an extension of the shank and is an enlarged portion of same, such that a person using the key can manually hold the key head, insert the shank into the keyhole, and exert a force on the head, thus completing the operation of locking or unlocking a lock.

A variety of physical ailments can reduce the ability of a key user to exert sufficient rotative force or torque on the key in order to rotate the lock. Such physical ailments may include but not are not limited to as carpel-tunnel syndrome and arthritis. Even further, some key users may suffer from poor eyesight or age related eyesight conditions that make visualization of the keyhole difficult in low light conditions.

Thus, there is a need for a device that assists a user in gripping an turning a key thereby enabling the user to operate the lock. Such a device should further implement a lighting mechanism to enable the key user to visualize the keyhole in low light conditions. The present invention and its embodiments meets and exceeds these objectives.

### Review of Related Technology:

U.S. Pat. No. 4,991,417 pertains to a key extension for the physically impaired that consists of a shank portion with an enlarged handle portion affixed to one end and a head portion affixed to a second end of the shank portion. The head portion retains a bow of a standard key therein so that a blade of the standard key can be inserted within a lock allowing the physically impaired to turn the key extension to operate the lock.

U.S. Pat. No. 4,787,016 pertains to an improved light attachable to a key having a housing and back plate having substantially similar widths between which is secured to the head portion of a key. The housing encases a frame formed with recesses to accept a battery, light bulb, contacts and a switch. The frame fits into the back side of the housing such that a flat back side is formed which allows the head of a key which abuts the back side of the housing to overhang the width of the housing. The back plate attaches to the housing by means of a rectangular tab on one edge of the back plate which engages a correspondingly shaped groove in the housing, and by means of a screw from the face of the housing through a hole in the head of the key to the face of the back plate. The back plate is formed so as to have three open sides to similarly allow the head of the key to overhang its width. The key is held in place by the clamping force between the housing and the back plate provided by the screw, and also adhesive material disposed on the back plate to affix the key head to the back plate. Optionally, a bore is provided in the housing and frame to receive and carry a screwdriver used to tighten or remove the screw.

U.S. Patent Application 2013/0180084 pertains to a gripping device for distal end of a tool, product or device that is intended to be held and operated with one hand, that permits a user to insert his or her fingers through rigid finger slots lined with a soft material and rest his or her palm on a cushion connected to the tubular assembly into which said tool, product or device is permanently fixed. The tubular assembly has no less than one and no greater than four finger slots and the cushion is affixed to the tubular assembly opposite the finger slots for ergonomic ease and comfort. The soft material lining the finger slots allows for the inner circumference of the rigid finger slots to mold comfortably to the user's fingers. This gripping device is ideally suited for use with umbrellas.

U.S. Patent Application 2008/0105091 pertains to a handle for holding a tool piece having a fore end region and an aft end region, an edge at the fore end region of the handle defining an opening for inserting a tool piece, and a clamp connected to the fore end region of the handle having a pair of selectively movable, substantially diametrically opposed arms. A handle for a broken key extractor, the handle capable of holding a selectively removable 0.050-inch broken key extractor blade such that a tensile force of at least about 50 pounds is required to remove the blade from the handle using a SCOTT J Model Tensile Tester.

Various systems and methodologies are known in the art. However, their structure and means of operation are substantially different from the present disclosure. The other inventions fail to solve all the problems taught by the present disclosure. At least one embodiment of this invention is presented in the drawings below and will be described in more detail herein.

### SUMMARY OF THE EMBODIMENTS

Generally, the present invention and its embodiments provide for a device that assists a user in gripping and turning a key. Further, the device preferably assists a user in visualizing a keyhole via a lighting mechanism. The body of the device is designed not only to be ergonomic, but to further provide an increased surface area allowing additional force to be applied when rotating the key once inserted into the lock.

In one embodiment there is a key grip device having a device body comprising a first surface and a second surface with the second surface being opposite the first surface, wherein the first surface comprises a planar surface and a raised surface; a clamping mechanism operably coupled to a rotatable positioning mechanism, the clamping mechanism being configured to retain a position of at least one key; a locking mechanism configured to maintain a position of the clamping mechanism, wherein the locking mechanism has a slidable cover configured to prevent interaction with the locking mechanism; and at least one light source contained within the raised surface.

In another embodiment of the present invention there is a key grip device having a quadrilateral device body comprising a first surface and a second surface with the second surface being opposite the first surface, wherein the first surface comprises a planar surface and a rounded raised surface; a clamping mechanism operably coupled to a rotatable positioning mechanism, wherein rotation of the rotatable positioning mechanism causes the clamping mechanism to raise or lower; a depressible locking mechanism configured to maintain a position of the clamping mechanism, wherein the locking mechanism has a slidable cover configured to prevent interaction with the locking mechanism; and a spring-loaded arm configured to enable a key ring to be coupled to the device; and at least one light source contained within the rounded raised surface, wherein the at least one light source is squeezably operated.

In yet another embodiment of the present invention there is a key grip device having a quadrilateral device body covered in a gel-based material, the quadrilateral device body comprising a first surface, at least one side surface, and a second surface with the second surface being opposite the first surface, wherein the first surface comprises a planar surface and a rounded raised surface, with the rounded raised surface being disposed on a first side of the planar surface, and wherein there is at least one slot disposed in the at least one side surface; at least one clamping wall operably coupled to a rotatable positioning mechanism, wherein rotation of the rotatable positioning mechanism causes the at least one clamping wall to raise or lower relative to a position of the quadrilateral device body; a depressible button configured to lock a position of the at least one clamping wall, wherein the depressible button has a slidable cover configured to selectively cover the depressible button thereby preventing interaction with the depressible button; and a spring-loaded arm configured to enable a key ring to be coupled to the key grip device; and at least one light source configured to emit light proximate to the at least one slot.

In general, the embodiments of the present invention succeeds in conferring the following, and others not mentioned, benefits and objectives.

It is an object of the present application to provide a device that illuminates a keyhole.

It is an object of the present application to provide a device that grips a key independent of a user's hand.

It is an object of the present application to provide a device that facilitates turning of a key.

It is an object of the present application to provide a device that is easy to use and lightweight.

It is an object of the present application to provide a device that incorporates an ergonomic design.

It is an object of the present application to provide a device that is soft and comfortable to use.

It is an object of the present application to provide a device that is capable of being clipped to a keychain or key ring.

It is an object of the present application to provide a device that has a locking mechanism to prevent the key from loosening from the device.

It is an object of the present application to provide a device that is inexpensive.

### BRIEF DESCRIPTION OF THE DRAWINGS

FIG. 1 is a rear perspective view of an embodiment of the present invention.

FIG. 2 is a front perspective view of an embodiment of the present invention.

FIG. 3 is a back view of an embodiment of the present invention.

FIG. 4 is a front view of an embodiment of the present invention.

FIG. 5 is a left side view of an embodiment of the present invention.

FIG. 6 is a right side view of an embodiment of the present invention.

FIG. 7 is a top view of an embodiment of the present invention.

FIG. 8 is a bottom view of an embodiment of the present invention.

### DESCRIPTION OF THE PREFERRED EMBODIMENTS

The preferred embodiments of the present invention will now be described with reference to the drawings. Identical elements in the various figures are identified with the same reference numerals.

Reference will now be made in detail to each embodiment of the present invention. Such embodiments are provided by way of explanation of the present invention, which is not intended to be limited thereto. In fact, those of ordinary skill in the art may appreciate upon reading the present specification and viewing the present drawings that various modifications and variations can be made thereto.

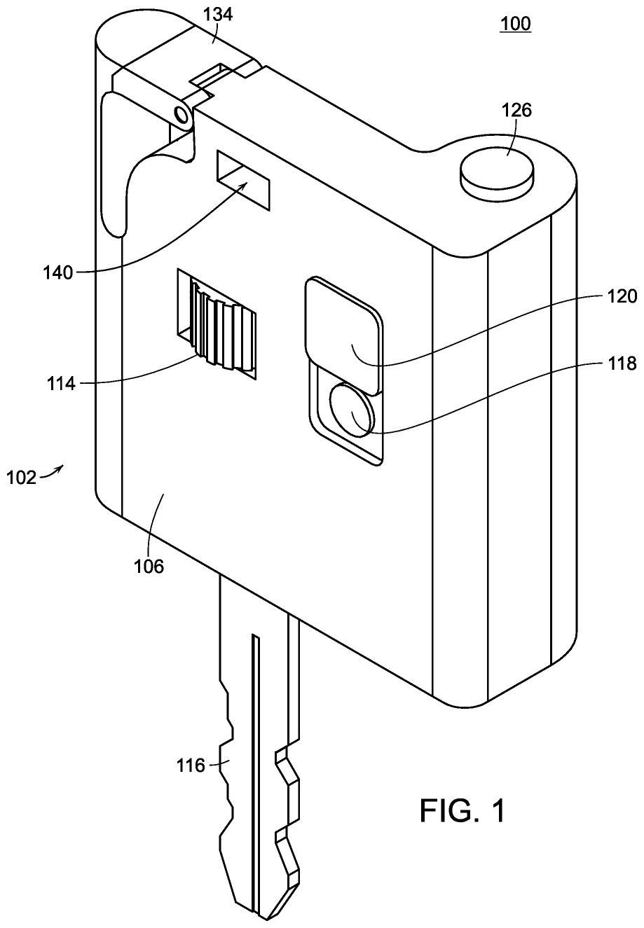

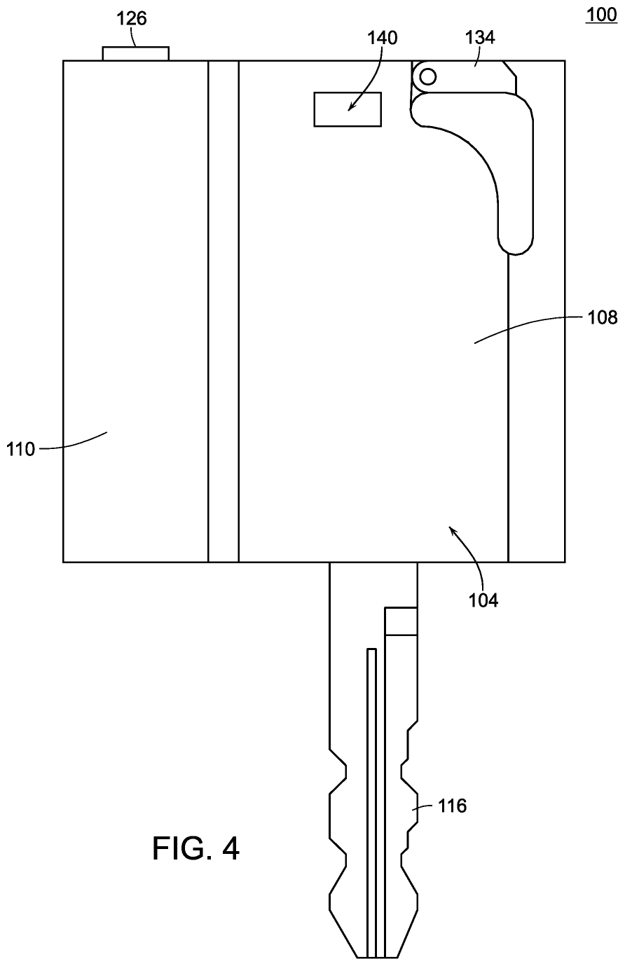

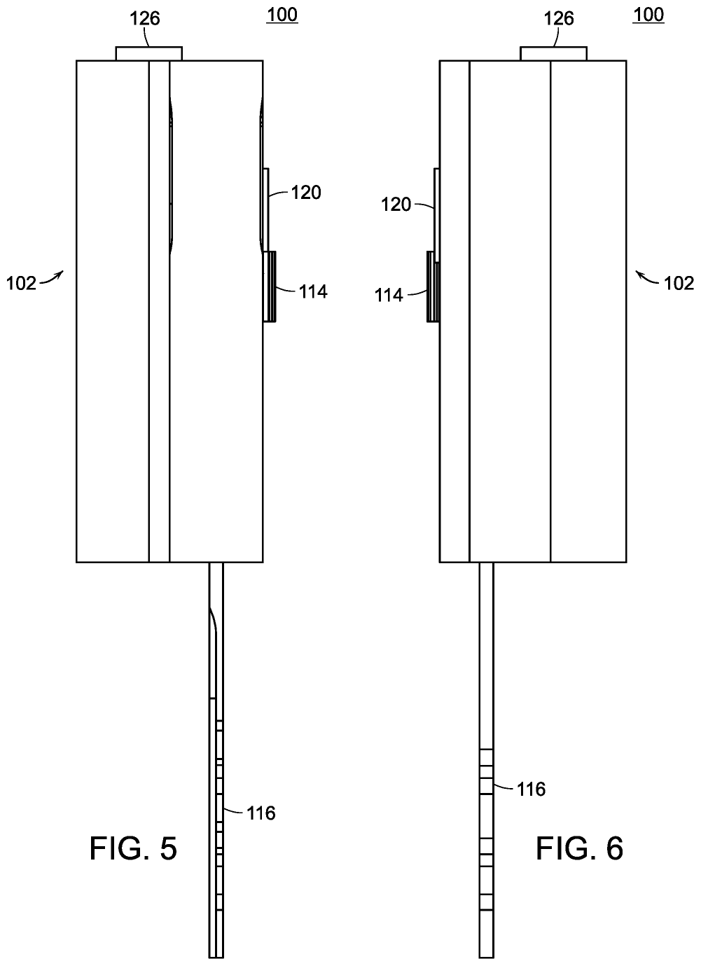

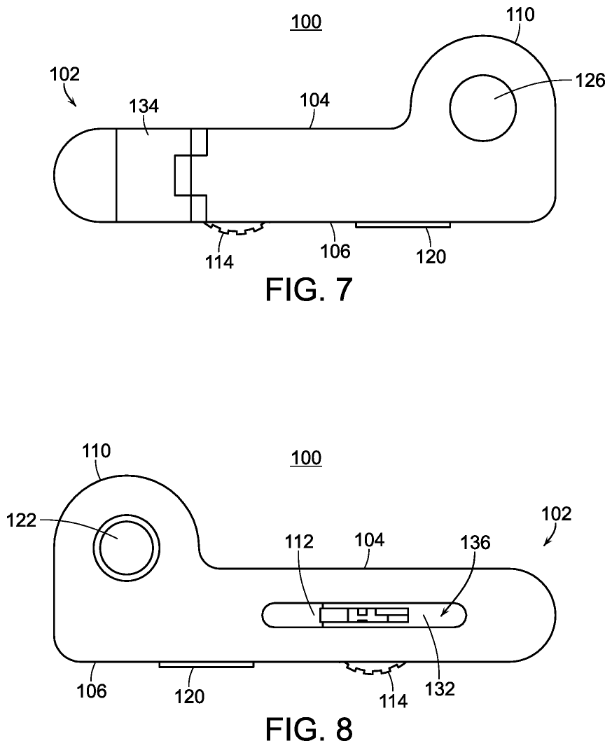

Referring now to FIGS. 1-8, there is a key grip device 100 generally having a device body 102, first surface 104, second surface 106, planar surface 108, raised surface 110, clamping mechanism 112, rotatable positioning mechanism 114, locking mechanism 118, slidable cover 120, and at least one light source 122.

The key grip device 100 may be configured to be utilized by a user who is predominantly left-handed or right-handed. The only difference in such orientations would be the arrangement of components essentially being mirror images of one another. For example, while in the right-handed configuration, the at least one light source 122 may be disposed along a right side of the device 100, whereas in the left-handed configuration the at least one light source may be disposed along a left side of the device 100.

The device body 102 may comprise a variety of materials including but not limited to polyethylene terephthalate (PET), polyethylene (PE), high-density polyethylene, polyvinyl chloride (PVC), polyvinylidene chloride (PVDC), low-density polyethylene (LDPE), polypropylene (PP), polystyrene (PS), high impact polystyrene (HIPS) and polycarbonate (PC), fiber reinforced plastics, metal composites, carbon fiber, and Kevlar®, lightweight metals such as aluminum and other pure metals as well as various alloys, or any combination thereof. In at least one preferred embodiment, the device body 102 is coated, fully or partially, in a gel-like material 124 that provides comfort and additional grip to the user of the device 100.

The device body 102 has a first surface 104 and a second surface 106, which are located opposite one another. The first surface 104 has a planar surface 108 and a raised surface 110. The planar surface 108 serves to provide a planar area for a user's hand to be positioned. The raised surface 110 houses the lighting mechanism 122, as well as provide a surface by which a portion of the user's hand can be positioned in a proximity thereto. When a user attempts to rotate a key, once inserted into a lock, using an embodiment of the present invention, the raised surface 110 acts to provide a surface upon which additional force or torque may be applied by the user thereby allowing one to easily turn the key to operate the lock.

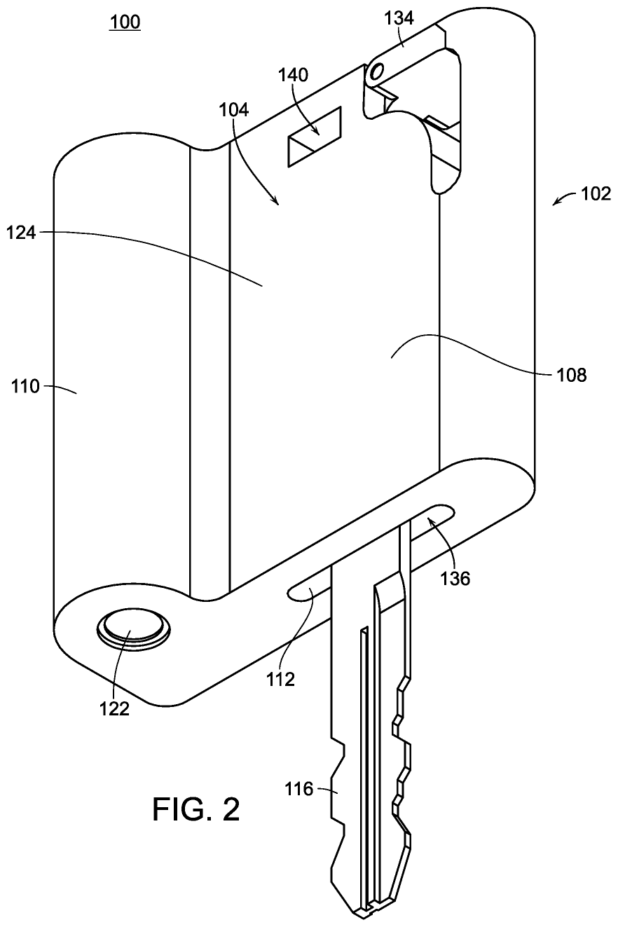

As shown in FIG. 2, the device 100 has a slot 136 that is configured to retain a key 116. Internally, as shown in FIG. 6, there is a clamping mechanism 112 which comprises at least one and, in some embodiments, two walls that are repositionable based on the dimensions of the key 116.

The clamping mechanism 112 interfaces with the rotatable positioning mechanism 114. The structural relationship between the clamping mechanism 112 and the rotatable positioning mechanism 114 is such that rotation of the rotatable positioning mechanism 114 causes movement of the clamping mechanism 112 thereby applying a force to the key 116. The key is retained within the slot 136 by this force.

Typically, when one clamping wall is utilized, rotation the of rotatable positioning mechanism 114 causes the clamping wall to move vertically (when the device 100 is viewed from the side) to apply a force to the key 116 and to “trap” the key between the clamping wall and another internal surface of the device body 102. When two clamping walls are used, rotation of the rotatable positioning mechanism 114 causes both clamping walls to move vertically, as noted above, to secure the key 116. In this embodiment, the two clamping walls act like a vice to come together and secure the key 116.

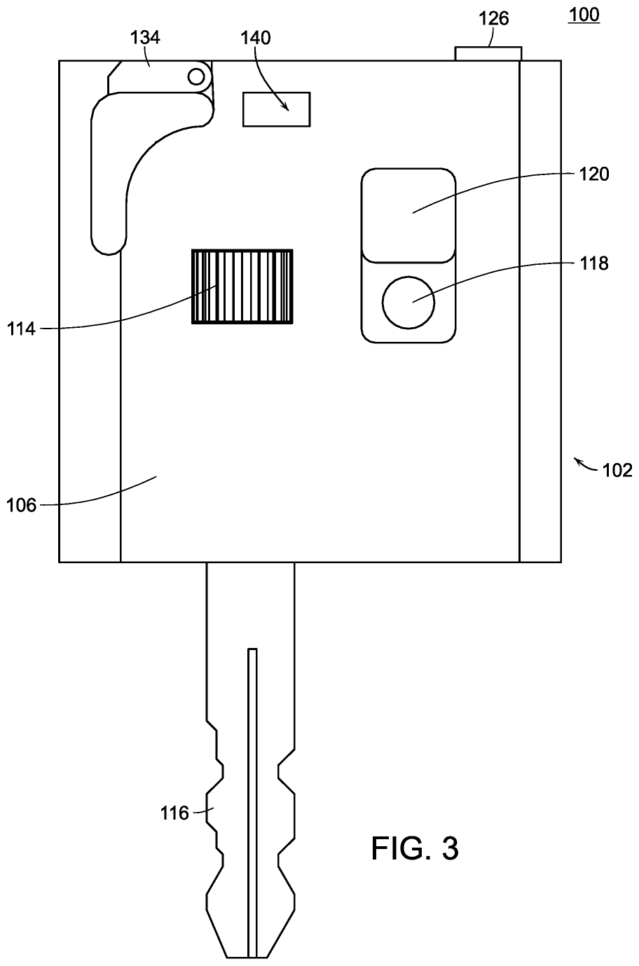

Once the position of the key 116 has been secured by the clamping mechanism 112, a user can interact with the locking mechanism 118, as shown in at least FIG. 3, to lock the position of the clamping mechanism 112. The locking mechanism 118 preferably takes the form of a depressible button, although other form factors are contained under the purview of this invention. In at least one embodiment, the locking mechanism 118 engages or disengages a securement mechanism 132. The securement mechanism 132 prevents movement of the clamping mechanism 112 once engaged and permits movements of the clamping mechanism 112 once disengaged.

The lighting mechanism 122, as shown in FIGS. 2 and 8, may comprise a light emitting device operated by a depressible switch 126. The depressible switch 126, as shown in FIG. 1, may cause the light emitting device to emit light upon depression of the depressible switch 126, and may then cause the light emitting device to cease to emit light upon a subsequent depression of the depressible switch 126. In some embodiments, a “squeeze” mechanism may be utilized to operate the lighting mechanism 122 wherein a user squeezes the device body 102 to cause the lighting mechanism 122 to emit light and subsequently squeezes the device body 102 to cause the lighting mechanism 122 to cease to emit light.

A spring-arm 134 may be used to attach or couple the device 100 to a set of keys, key ring, or other suitable device. The spring-arm 134 may further a have a slidable covering disposed along a top surface of the device body 102 and spring-arm 134. By sliding the slidable covering over the spring-arm, a user can prevent the spring-arm from being depressed thereby allowing an item coupled to the device 100 to be removed. When such removal of the secondary item is desired, a user may simply slide back the slidable covering thereby exposing the spring-arm 134. Alternatively, a user may use the key ring slot 140 that passes through the device body 102 to couple the device to a key ring or other suitable structure.

A user may utilize a slidable cover 120 to prevent inadvertent engagement or disengagement of the clamping mechanism 112. The slidable cover 120 may be positioned in at least a first position and a second position. In a first position, the slidable cover 120 is positioned such that the locking mechanism 118 may be interacted with by a user. In a second position, the slidable cover 120 is positioned such that the locking mechanism 118 may not be interacted with by a user (i.e. covers the locking mechanism). In some embodiments, the slidable cover 120 may be hinged to otherwise structured to provide selective covering/uncovering of the locking mechanism 118.

Although this invention has been described with a certain degree of particularity, it is to be understood that the present disclosure has been made only by way of illustration and that numerous changes in the details of construction and arrangement of parts may be resorted to without departing from the spirit and the scope of the invention.

What is claimed is:

1. A key grip device comprising:
a device body comprising a first surface and a second surface with the second surface being opposite the first surface, wherein the first surface comprises a planar surface and a raised surface;
a clamping mechanism operably coupled to a rotatable positioning mechanism, the clamping mechanism being configured to retain a position of at least one key, wherein rotation of the rotatable positioning mechanism causes the clamping mechanism to move relative to a position of the device body to apply a force to the at least one key to retain the at least one key within a slot of the device body;
a locking mechanism comprising a depressible button, the locking mechanism being configured to engage a securement mechanism and maintain a position of the clamping mechanism,
wherein depression of the depressible button disengages or engages the securement mechanism with the rotatable positioning mechanism, and
wherein the securement mechanism prevents movement of the clamping mechanism once engaged and permits movement of the clamping mechanism once disengaged; and
at least one light source contained within the raised surface.

2. The device of claim 1 further comprising a gel layer disposed over a portion of the device body.

3. The device of claim 1, wherein the at least one light source is operated via another depressible button.

4. The device of claim 1, wherein the at least one light source is operated via a squeezable mechanism such that squeezing the device body a first time causes the at least one light source to emit light and squeezing the body a second time causes the at least one light source to cease to emit the light.

5. The device of claim 1 wherein the clamping mechanism comprises at least one clamping wall configured to be raised or lowered to retain the position of the at least one key.

6. The device of claim 5,
wherein there are two clamping walls, and
wherein rotation of the rotatable positioning mechanism causes the two clamping walls to raise or lower relative to a position of the device body to secure the at least one key within the slot of the device body.

7. A key grip device comprising:
a quadrilateral device body comprising a first surface and a second surface with the second surface being opposite the first surface, wherein the first surface comprises a planar surface and a rounded raised surface;
a clamping mechanism operably coupled to a rotatable positioning mechanism, wherein rotation of the rotatable positioning mechanism causes the clamping mechanism to raise or lower relative to a position of the quadrilateral device body to apply force to a key to retain the key within a slot of the quadrilateral device body;
a depressible locking mechanism comprising a depressible button, the depressible locking mechanism being configured to engage a securement mechanism and maintain a position of the clamping mechanism,
wherein depression of the depressible button disengages or engages the securement mechanism with the rotatable positioning mechanism, and
wherein the securement mechanism prevents movement of the clamping mechanism once engaged and permits movement of the clamping mechanism once disengaged; and
a spring-loaded arm configured to enable a key ring to be coupled to the device; and at least one light source contained within the rounded raised surface, wherein the at least one light source is squeezably operated.

8. The device of claim 7 wherein the depressible locking mechanism is disposed on the second surface.

9. The device of claim 7 wherein the rotatable positioning mechanism is disposed on the second surface.

10. A key grip device comprising:
a quadrilateral device body covered in a gel-based material, the quadrilateral device body comprising a first surface, at least one side surface, and a second surface with the second surface being opposite the first surface,
wherein the first surface comprises a planar surface and a rounded raised surface, with the rounded raised surface being disposed on a first side of the planar surface, and
wherein there is at least one slot disposed in the at least one side surface;
at least one clamping wall operably coupled to a rotatable positioning mechanism, wherein rotation of the rotatable positioning mechanism causes the at least one clamping wall to raise or lower relative to a position of the quadrilateral device body to apply a force to a key to retain the key within the at least one slot;
a depressible button configured to lock a position of the at least one clamping wall,
wherein depression of the depressible button disengages or engages a securement mechanism with the rotatable positioning mechanism, and
wherein the securement mechanism prevents movement of the clamping mechanism once engaged and permits movement of the clamping mechanism once disengaged;
a spring-loaded arm configured to enable a key ring to be coupled to the key grip device; and
at least one light source configured to emit light proximate to the at least one slot.

11. The device of claim 10 further comprising:
a slidable covering configured to selectively cover the spring-loaded arm, wherein the slidable covering prevents operation of the spring-loaded arm when covering the spring-loaded arm.

12. The device of claim 10 wherein the at least one light source is operated via another depressible button or a squeeze mechanism.

13. The device of claim 10 wherein there are two clamping walls.

14. The device of claim 10 wherein the at least one clamping wall is located within the quadrilateral device body.

15. The device of claim 10 wherein the at least one light source emits light in the same direction as a key coupled to the device is oriented.
